(19) United States
(12) Patent Application Publication
(10) Pub. No.: US 2008/0041027 A1
(43) Pub. Date: Feb. 21, 2008

(54) FLOATING CUTTER FOR MULCHER

(76) Inventor: Dwight Qualie, Drayton Valley (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/829,841

(22) Filed: Jul. 27, 2007

(30) Foreign Application Priority Data
Aug. 17, 2006 (CA) 2556845

(51) Int. Cl. B02C 18/00

(52) U.S. Cl. 56/289

(57) ABSTRACT

A floating cutter includes a body having a first end, a second end, a first face, a second face opposed to the first face. Attachment ears are provided at the first end adapted to attach the body to a drive system of a mulcher. A female coupling is on the first face at the second end. A tooth having a cutting head and a depending male coupling adapted to mate with the female coupling is provided on the body. A bolt locks the male coupling within the female coupling to prevent separation during use. A shoulder projecting from the first face of the body adjacent the female coupling prevents relative rotation of the body and the tooth during use.

### FIELD

The present invention relates to a floating cutter for a mulcher.

### BACKGROUND

Mulchers are used to clear brush. They have a drive system to which are attached a plurality of floating cutters, each of which has one or more cutter teeth.

### SUMMARY

According to the present invention there is provided a floating cutter, including a body having a first end, a second end, a first face, a second face opposed to the first face. Attachment means are provided at the first end adapted to attach the body to a drive system of a mulcher. A female coupling is on the first face at the second end. A tooth having a cutting head and a depending male coupling adapted to mate with the female coupling is provided on the body. There is means for locking the male coupling within the female coupling to prevent separation during use, and means for preventing relative rotation of the body and the tooth during use.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is an exploded view of a floating cutter.

FIG. 2 is a bottom plan view of the floating cutter body.

FIG. 3 is a detailed perspective view of the floating cutter installed on a mulcher.

FIG. 4 is a perspective view of floating cutters installed on a portion of a mulcher.

### DETAILED DESCRIPTION

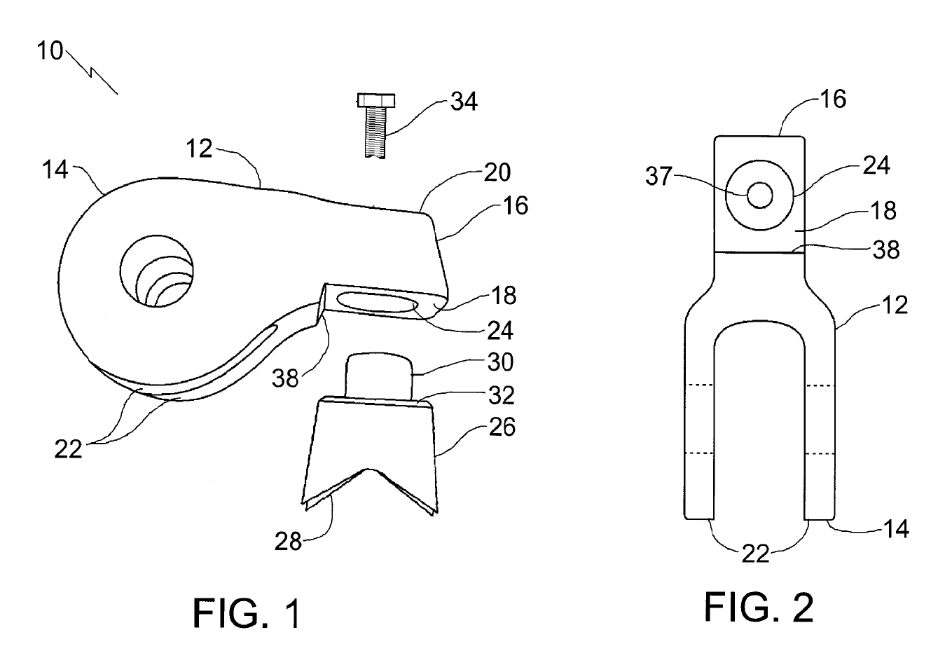

The preferred embodiment, a floating cutter generally identified by reference numeral 10, will now be described with reference to FIG. 1 through 4.

Structure and Relationship of Parts:

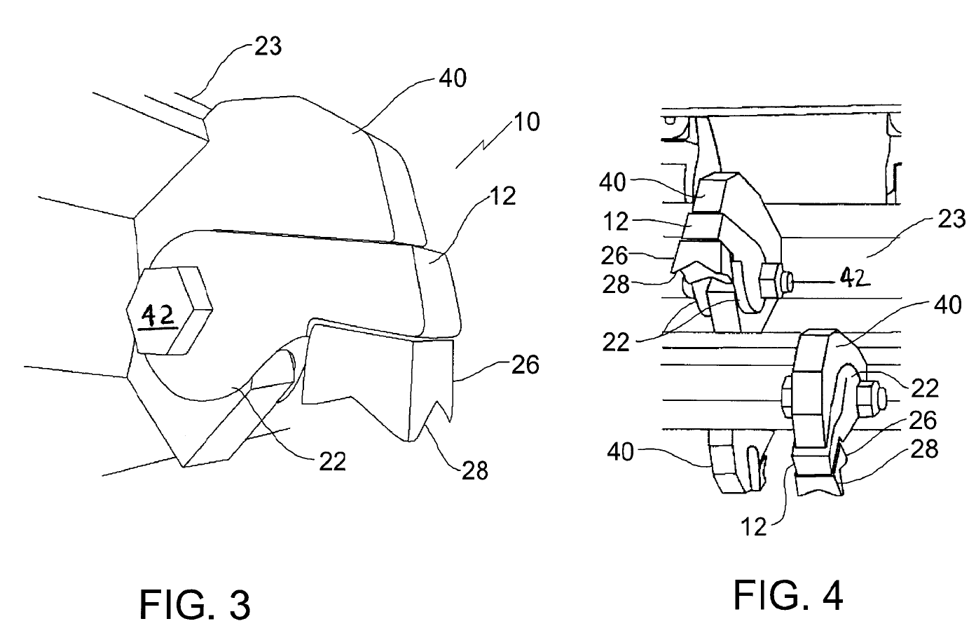

Referring to FIG. 1, floating cutter 10 includes a body 12 having a first end 14, a second end 16, a first face 18, and a second face 20 opposed to first face 18. Positioned at first end 14 are means, such as attachment ears 22, to attach body 12 to a flange 40 of a drive system 23 of a mulcher, as shown in FIGS. 3 and 4. Referring again to FIG. 1, at second end 16, there is a female coupling 24 on first face 18 which extends through body 12 between first face 18 and second face 20. There is also a tooth 26 with a cutting head 28. Tooth 26 has a depending male coupling 30 adapted to mate with female coupling 24 on body 12. Male coupling 30 is locked within female coupling 24 to prevent separation during use. As female coupling 24 extends through body 12, this is done by providing a locking member, such as bolt 34 that engages a remote end 36 of male coupling 30 at second face 20 through a narrower portion 37 of female coupling 24. Head 35 of bolt 34 is too large to pass through narrower portion 37 of female coupling 24. Narrower portion 37 can be seen in FIG. 2. It may be that female coupling 24 is indented slightly (not shown) on second face 20 to receive bolt 34, such that it lies flush or below second face 20, so as not to interfere with drive system 23.

Referring to FIG. 1, as shown, cutting head 28 on tooth 26 has a square base with planar edges 32. A shoulder 38 projects from first face 18 of body 12 adjacent female coupling 24 which engages one of the planar edges 32 of cutting head 28, such that relative rotation of body 12 and tooth 26 is prevented. It will be understood that instead of square, tooth 26 may have a different shape, with shoulder 38 designed to engage that shape as well. It will also be understood that different means for preventing relative rotation of body 12 and tooth 26 could also be used.

Operation:

Referring to FIG. 1 through 4, floating cutter 10 is provided as described above. Referring to FIG. 3, body 12 of floating cutter 10 is attached to drive system 23 of a mulcher by aligning attachment ears 22 on each side of a flange 40 of drive system 23, and securing the two using a pin connector 42, such as a bolt. Referring to FIG. 4, it can be seen that flanges 40 may be positioned around drive system 23 in a staggered manner, as is known in the art. Referring to FIG. 1, male coupling 30 of tooth 26 is inserted into female coupling 24 of body 12, and secured using bolt 34. Tooth 26 is inserted such that planar edge 32 abuts shoulder 38 to prevent relative rotation of tooth 26 and shoulder 38 during use. As cutting head 28 wears on one side, bolt 34 may be loosened to rotate cutting head 28 such that a less work portion is on the outside, or tooth 26 may be removed and replaced.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiments without departing from scope of the Claims.

What is claimed is:

1. A floating cutter comprising:
a body having a first end, a second end, a first face, a second face opposed to the first face;
attachment means at the first end adapted to attach the body to a drive system of a mulcher;
a female coupling on the first face at the second end;
a tooth having a cutting head and a depending male coupling adapted to mate with the female coupling on the body;
means for locking the male coupling within the female coupling to prevent separation during use; and
means for preventing relative rotation of the body and the tooth during use.

2. The floating cutter as defined in claim 1, wherein the attachment means are attachment ears.

3. The floating cutter as defined in claim 1, wherein the female coupling extends through the body between the first face and the second face, and the means for locking the male coupling within the female coupling includes a locking member that engages a remote end of the male coupling at the second face, the locking member being too large to pass through the female coupling.

4. The floating cutter as defined in claim 1, wherein the cutting head on the tooth is a polygon with planar edges, and the means for preventing relative rotation of the body and the tooth is a shoulder projecting from the first face of the body adjacent the female coupling which engages one of the planar edges of the cutting head.
